(19) United States
(12) Patent Application Publication
(10) Pub. No.: US 2022/0214199 A1
(43) Pub. Date: Jul. 7, 2022

(54) NANO FLOW SENSORS

(71) Applicant: BOARD OF REGENTS, THE UNIVERSITY OF TEXAS SYSTEM, Austin, TX (US)

(72) Inventors: Purnendu K. Dasgupta, Arlington, OH (US); Chuchu Qin, Arlington, TX (US)

(21) Appl. No.: 16/932,283

(22) Filed: Jul. 17, 2020

Related U.S. Application Data
(60) Provisional application No. 62/875,685, filed on Jul. 18, 2019.

(51) Int. Cl. G01F 1/7086; G01N 21/64

(52) U.S. Cl. CPC G01F 1/7086; G01N 2021/6439; G01N 21/6428

(57) ABSTRACT

A flow meter comprises a capillary, a first and second fluid flow marker, and one or more sensors. The capillary has a longitudinally extending fluid receiving space, with a first end and a second end. The first and second fluid flow markers are immiscible and are positioned in the fluid receiving space. The one or more sensors are positioned along the capillary. A method for measuring flow rates comprises the steps of introducing a first liquid into a flow meter. That first liquid flows into the fluid receiving space at the first end of the capillary thereby displacing the first fluid flow marker and the second fluid flow marker towards the second end of the capillary. The interface between the first fluid flow marker and the second fluid flow marker is measured with one or more sensors to determine the flow rate of the first liquid.

### CROSS REFERENCE TO RELATED APPLICATIONS

The present application hereby claims the benefit of the provisional patent application of the same title, Ser. No. 62/875,685, filed on Jul. 18, 2019, the disclosure of which is herein incorporated by reference in its entirety.

### STATEMENT REGARDING GOVERNMENT FUNDING

This invention was made with government support under grant number NNX15AM76G awarded by the National Aeronautics and Space Administration (NASA), and under grant number CHE-1506572 awarded by the National Science Foundation. The government retains certain rights to this invention.

### BACKGROUND

Aside from microfluidic systems, many current capillary scale analytical approaches operate at flow rates below 25 nL/min. Recent examples include open tubular ion chromatography columns with a van Deemter optimum at 18 nL/min, LC-MS/MS systems based on packed 25 μm i.d. columns operating at 10 nL/min, CE-MS systems operating at 5 nL/min, to open tubular reverse phase LC separations in 2 μm i.d. columns operating at a flow rate of 0.2 nL/min. Pumping and gradient generation systems that can operate at the nL/min scale are commercially available. Low pressure infusion pumps used in biomedical research routinely operate down to 17 nL/min; even implantable versions that go down to 33 nL/min with a battery life of up to 7 years are in routine use. Reviews cover how high pressure pumps may operate in a split or splitless manner to generate flows in the nL/min regime, but practical methods for reliably monitoring such flow rates, especially those that can accommodate solvent gradients, are noticeably lacking. Precise flowmetry is essential for the overall reliability and integrity of analytical systems. With most liquids at sub-μL/min flow rates, any leak evaporates long before it is visible. Thus, an affordable monitor applicable in this flow regime can greatly facilitate instrument/method development as well as help troubleshoot processes that operate in this flow scale.

This disclosure is generally related to liquid flow meters, and, more specifically, to sensors measuring the flow of liquids in the nanoliter per minute scale (nano-flow liquid meter).

Traditionally, low liquid flow measurements have relied on gravimetry, thermal methods, or front tracking measurements. The liquid is allowed to flow into a small vessel, or a narrow bore transparent tube. This allows (periodic) mass or volume estimation. Such approaches become tedious and error-prone for sub-μL/min flow rates and require inordinately long times for a single measurement. Corrections for evaporation, thermal influence, pulsation, buoyancy, and the like need to be implemented. While in some cases all of these can be properly carried out, near real time flow measurements simply are not possible, and are of particular concern when flow rates are variable rather than constant. The urgent need for a device that can measure flow rates down to ˜1 nL/min has been elegantly stated by NIST researchers in Patrone, P. N. et al., Dynamic Measurement of Nanoflows: Analysis and Theory of an Optofluidic Flowmeter. Phys. Rev. Appl. 2019, 11.3: 034025.

### BRIEF SUMMARY

A flow meter comprises a capillary, a first and second fluid flow marker, and one or more sensors. The capillary has a fluid receiving space, with a first end and a second end. The first and second fluid flow markers are immiscible and are positioned in the fluid receiving space, wherein the first fluid flow marker is adjacent to the second fluid flow marker. The one or more sensors are positioned along the capillary.

A method for measuring flow rates comprises the steps of introducing a first liquid into a flow meter. That first liquid flows into the fluid receiving space at the first end of the capillary thereby displacing the first fluid flow marker and the second fluid flow marker towards the second end of the capillary. Either the movement of the interface between the first fluid flow marker and the second fluid flow marker or the movement of one or more entire flow marker is measured with one or more sensors to determine the flow rate of the first liquid.

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIG. 1 is an exemplary multi-segment flow marker having two immiscible flow markers of different segment lengths.

FIG. 2 is a schematic of a nano flow meter test setup.

FIG. 3 is a schematic of a flow switching configuration using two 3-port solenoid valves.

FIG. 4 is a graph of a response of an admittance sensor to flow of a portion of the multi-segment flow marker similar to the one shown in FIG. 1.

FIG. 5 is a graph of a time of flight of a flow marker segment verses a flow rate of a sample fluid.

FIG. 6 is a graph of a sensor response time to changes in a flow rate.

FIG. 7 is a graph of a time of flight flow marker segment to changes in temperature.

FIG. 8A is a picture of a normal (untreated) fused silica capillary having a fluorocarbon marker segment.

FIG. 8B is a picture of a capillary that has been fluorosilylated and has a fluorocarbon marker segment.

FIG. 9 is a schematic view of an exemplary LED-photodiode based transmittance detector incorporated into a nano flow meter described herein.

FIG. 10 is a picture of two superimposed images showing movement of a flow marker segment in a nano flow meter described herein.

FIG. 11 is a schematic of a reversible flow mechanism.

### DETAILED DESCRIPTION

The nano flow meters described herein measure low nL/min flow rates, or in some cases, sub-nL/min flow rates. The flow meter comprises a capillary, a first fluid flow marker, a second fluid flow marker, and one or more sensors. The capillary has a fluid receiving space, with a first end and a second end. The second fluid flow marker is immiscible with the first fluid flow marker. The first and second fluid flow markers are positioned in the fluid receiving space, wherein the first fluid flow marker is adjacent to the second fluid flow marker. One or more sensors are positioned along the capillary.

In some embodiments, there is a plurality of first and second fluid flow markers. The first and second fluid flow markers are positioned in an alternating sequence of fluid segments in the fluid receiving space of the capillary to form a multi-segment marker “train.” In some embodiments, there is at least one first fluid flow marker and at least two second fluid flow markers. In some embodiments, each of the first fluid flow marker segments have the same length. In some embodiments, each of the second fluid flow marker segments have the same length. In some embodiments, each of the first fluid flow marker segments have a different length from the other first fluid flow marker segments. In some embodiments, each of the second fluid flow marker segments have a different length from the other second fluid flow marker segments.

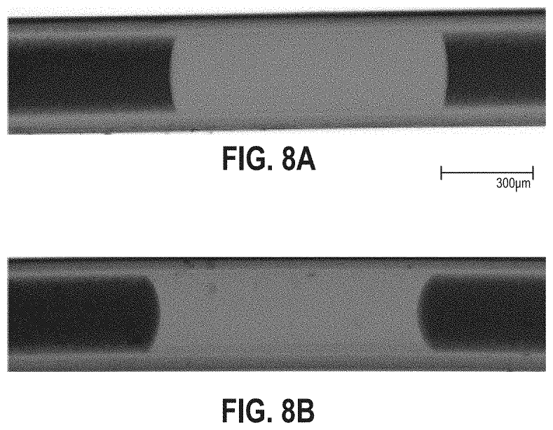

There is an interface between the first and second fluid flow markers. The interface between the first and second fluid flow markers is in the shape of a meniscus. See FIGS. 8A and 8B.

The sensors are designed to evaluate if a fluid flow marker is in its field of perception. Examples of sensors include, but are not limited to those that use electromagnetic waves for interrogation, such as optical sensors and electrical admittance sensors. In some embodiments, the flow meter comprises optical sensors, admittance sensors, capacitance sensors, other electromagnetic sensors, acoustic sensors, or combinations thereof. In some embodiments, the flow meter comprises sensors selected from optical sensors, admittance sensors, capacitance sensors, or a combination thereof. In some embodiments, there is only one type of sensor. An optical sensor may measure the transmission, reflection, absorption, or emission of light by one or more of the fluid flow markers. Electrical admittance is the reciprocal of electrical impedance. Given constant dimensions of a test fluid between two interrogation electrodes, the observed impedance is a function of the dielectric constant of the fluid between the electrodes as well as the probe frequency if the fluid is a nonconductor. The impedance decreases and the admittance increases as the frequency or dielectric constant increases. If the fluid is a conductor, e.g., an aqueous salt solution, the admittance increases as the specific conductance of the fluid increases. In some embodiments, the interrogation electrodes are not in direct physical contact with the test fluid. The electromagnetic field from the electrodes couples to the fluid in a tube through the tube wall material, which is a dielectric. More of the field is coupled to the fluid when the tube wall material has a higher dielectric constant (e.g., 3.8 for fused silica, 3.5 for polyimide, 3.3 for polyetherether ketone (PEEK) compared to 2.1 for Teflon (poly(tetrafluoroethylene)). The one or more sensors are positioned along the capillary tube so their output changes when the properties of the fluid (s) flow in their field of perception. In some embodiments, one or more sensors are positioned along the capillary and can measure a time of flight (TOF) of one or more of the fluid flow markers.

A sensor can have a field of perception (FOP). In this context, the field of perception of the sensor is the distance along the capillary where a change in the fluid composition will result in a change in the sensor output. In some embodiments, the width of the field of perception of one or more sensors is larger than the axial width of the curved interface between the two fluid flow markers. When the field of perception width is larger than the width of the interface, the passage of the interface through the sensor FOP results in a continuous change in the sensor output, beginning from an output characteristic of that when the FOP contains only one fluid flow marker to when the FOP contains only the other fluid flow marker.

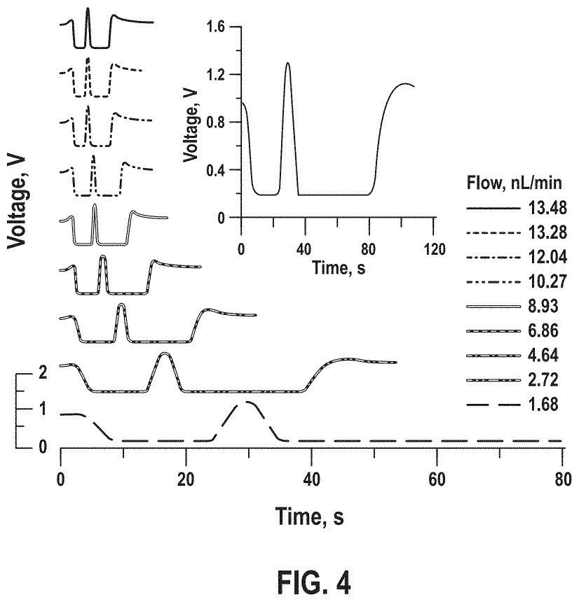

The response behavior of an admittance sensor at low flow rates (approaching 1 nL/min) appears in FIG. 4. The lowest output values (baseline output) with the fluorocarbon flow marker completely filling the gap is at ˜0.2 V, close to but not at zero output voltage.

There are myriad possible approaches to relate the observed or derived parameters from the detector output to the microscopically observed flow rate. One such parameter is the half width of the response peak elicited by the conductive segment. In reality, the measurement need not be the half-width, it can be the interval between any two chosen reference voltages on the ascending and descending parts of the response. There is no special significance to measuring the width at any specific relative peak height, it is important to note that if the conductive segment is long enough, the response can be flat-topped. In some embodiments, the sensor measures the change of the dielectric constant or the resistivity in the FOP over time due to the movement of the interface between the first and second fluid flow markers. The flow rate is calculated based on the rate of change of the measurement such as, for example, a time required for a change in admittance over a predetermined admittance interval. In an aspect, the predetermined admittance interval may be from 0.4 to 1.2 V.

For slow flow rates the passage of an interface can be used to measure the flow. At higher flow rates this may be the time of sight (TOS) for a given fluid flow marker crossing the field of vision and at still higher flow rates, the TOS for all the fluid flow markers. For very slow flow rates of flow, the TOS may do more than just rely on the passage of a flow marker interface that typically involves the gradual transition of the detector signal from one stable value to another, it may advantageously zoom in on that transition zone and the TOS value of interest may simply go from any arbitrarily chosen signal voltage to another in the signal transition zone. In some embodiments, a sensor measures the time it takes for a fluid flow marker to pass. The flow rate is then calculated based on the length of the fluid flow marker measured and the amount of time it took to pass.

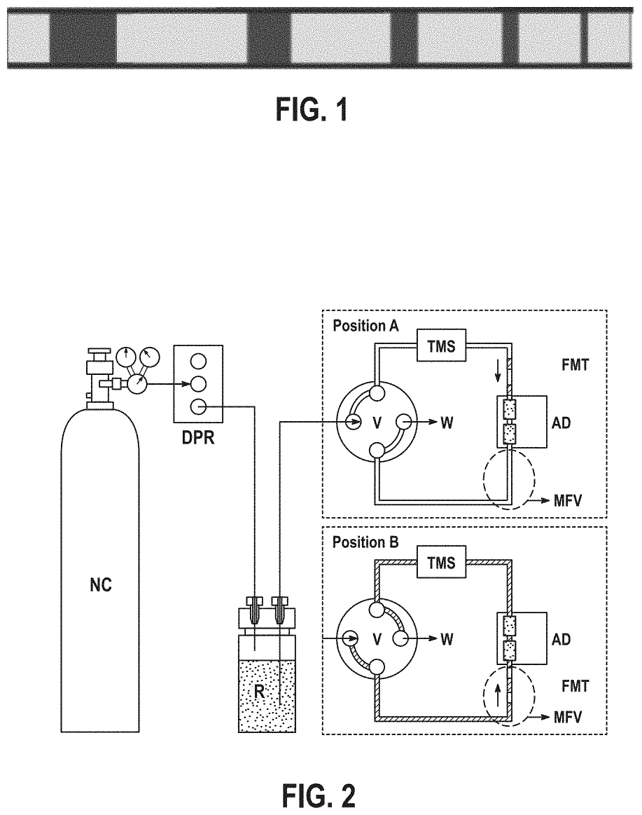

In some embodiments, the first fluid flow marker has a low dielectric constant, a high resistivity, or both, such as the fluorocarbon FC-40 (dielectric constant 1.9, resistivity 4×10¹⁵ ohm·cm) the second fluid flow marker has a high dielectric constant, a lower resistivity relative to the first fluid flow marker, or both; for example water (dielectric constant 78.3, specific resistivity 1.8×10⁷ ohm·cm). In some embodiments, the difference in dielectric constants between the first and second fluid flow markers is sufficient to be clearly distinguished by the admittance detector. In some embodiments, the difference in resistivity between the first and second fluid flow markers is sufficient to be clearly distinguished by the admittance detector. In some embodiments, a measurement sufficient to be clearly distinguished by the admittance detector is a change such as: ±0.5%, ±1%, ±5%, ±10%. As the salinity of an aqueous solution is increased, the dielectric constant does not change markedly but the conductivity increases significantly as exemplified by a 50 mM NaCl solution that has a specific resistivity of 200 ohm·cm. In some embodiments, the second fluid flow marker comprises fluorocarbon (FC) fluid such as FC-40 from the 3M company that has high resistivity (ρ), and low dielectric constant (k) that are optically transparent. An illustrative multi-segment marker train is shown in FIG. 1, where the dark bands are the low ρ, high k liquid and the light sections are the high ρ, low k liquid.

In some embodiments, the first fluid flow marker has a high dielectric constant and the second fluid flow marker has a low dielectric constant relative to the first fluid flow marker. In some embodiments, the first fluid flow marker is optically reflective.

In some embodiments, the second fluid flow marker comprises fluorocarbon. Examples of fluorocarbons include but are not limited to Fluorinert® FC-40 oil (a liquid mixture of completely fluorinated aliphatic compounds), perfluorohexane, perfluorooctane, perfluoro(2-butyl-tetrahydrofurane), and perfluorotripentylamine.

The fluid flow markers are immiscible in each other. Examples of an immiscible par of fluid flow markers are fluorocarbons and aqueous solutions. FC-40 solubility in water and water solubility in FC-40 are <5 and <7 ppm w/w.

In some embodiments, the first fluid flow marker is an aqueous salt solution, an ionic liquid, or a liquid metal. Examples of an aqueous salt solution include, but are not limited to sodium chloride, potassium nitrate, ammonium acetate, etc.; almost any stable electrolyte is acceptable for this purpose. In some embodiments, the solution concentrations are about 10 to about 100 mM but are not limited to this range. Examples of a liquid metal include but are not limited to mercury, gallium and gallium alloys like Galinstan (gallium-indium-tin). In some embodiments, the first flow marker is optically reflective as in a liquid metal. In some embodiments, the first flow marker is an aqueous salt solution.

In some embodiments, the terminal fluorocarbon fluid flow marker can be considered “guards”. Despite the extremely low solubility of FC's in any non-FC solvent, if any FC is removed by dissolution in the measured liquid, they will be removed from these terminal fluid flow markers while any other fluid enclosed by these outer guards, including other fluorocarbon segments do not come into contact with any external fluid. These guards protect and prevent dimensional change of the protected inner fluid flow markers. In some embodiments, to protect from the intrusion of the measured liquid stream past the guard fluid flow markers, the silica capillary can be fluorosilylated. This results in the wall having a fluorocarbon (FC)-like surface. The high affinity of the FC-coated wall for the FC fluid flow markers essentially eliminates the possibility of an intermediary wall film of any other liquid.

A capillary is a tube with a small internal diameter. In some embodiments, the internal diameter is from about 5 microns to about 400 microns, such as about 10 microns to about 400 microns, about 25 microns to about 400 microns, about 35 microns to about 400 microns, about 50 microns to about 400 microns, about 5 microns to about 300 microns, about 5 microns to about 250 microns, about 5 microns to about 200 microns, about 5 microns to about 100 microns, about 5 microns to about 50 microns, and about 5 microns to about 30 microns. In some embodiments, the capillary comprises silica or polytetrafluoroethylene (PTFE). In some embodiments, the internal wall of the capillary is at least partially fluorophilic, this may be accomplished by using PTFE or fluorosilylating a silica capillary. In some embodiments, the internal wall of the capillary is fluorophilic.

In some embodiments, the first and second fluid flow markers or their interface are recirculated by the sensor(s) by repeatedly reversing the flow in an observation loop as soon as the marker of interest has provided the desired reading.

In some embodiments, the flow meter comprises a valve. In some embodiments, the valve comprises a first port, a second port, a third port, and a fourth port. The flow meter is configured so that the first end of the capillary is fluidly connected to the first port of the valve and the second end of the capillary is fluidly connected to the second port of the valve. The third port is fluidly connected to the flow to be measured and the fourth port is the exit port or connects to further components downstream. The valve comprises two positions, a first position and a second position. In the first position, the valve is configured to fluidly connect the flow to be measured with the first end of the capillary and the second end of the capillary to the exit port. In the second position, the valve is configured to fluidly connect the flow to be measured with the second end of the capillary and the first end of the capillary to the exit port. This valve allows the direction of flow in the capillary to be reversed so that as the first and second fluid flow markers remain in the capillary as the flow meter is being used to measure flow. The flow markers travel in one direction during measurement in the capillary and when the valve is switched to the other position, the flow markers travel in the other direction during measurement; they never leave the observation/sensor-bearing loop.

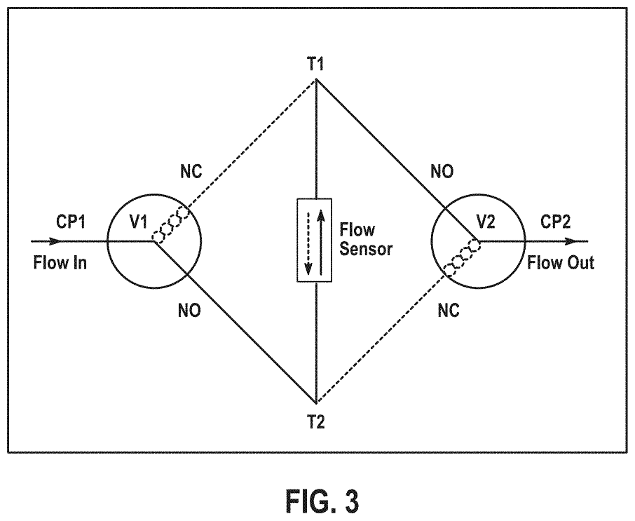

In some embodiments, the flow meter comprises at least two valves, which are at least two-position, three-port valves. They are configured as shown in FIG. 3. The flow to be measured is fluidically connected to the common port (CP1) of the first three-port valve (V1) and exits through the common port (CP2) of the second three port valve (V2). The normally closed (NC) port of the first valve and the normally open (NO) port of the second valve are connected to the opposing horizontal arms of a first tee (T1) and similarly, the NO port of the first valve and the NC port of the second valve are connected to the opposing arms of a second tee (T2). The T-arms of each tee are connected to one end of the flow sensing capillary containing the flow markers and one or more sensors. Both valves are switched in tandem so that when both valves are in the “closed position”, flow proceeds through first valve, its NC port, through the first tee (T1), through the flow sensing tube, through the second tee (T2) and the NC port of the second valve to exit. Before the flow markers exit this contained loop system, the valves switch to the open position and flow now occurs through the sensing tube in the opposite direction.

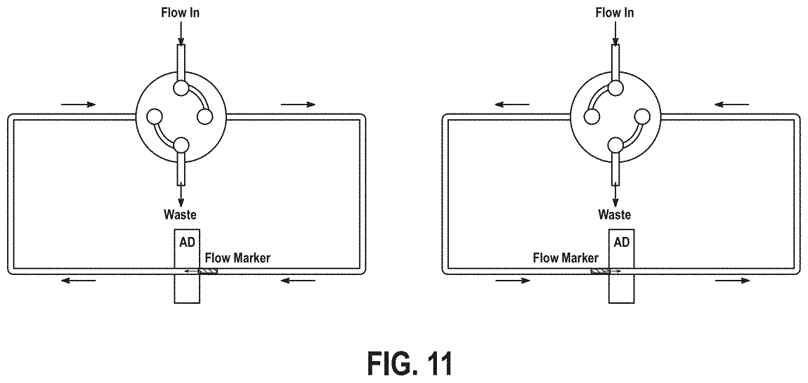

In some embodiments, the flow direction in the capillary of the nano flow meter can be reversed. For example, when a first liquid is introduced into the first end of the capillary, the first and second fluid flow markers with be displaced along the fluid receiving space of the capillary from the first end towards the second end. After one or more fluid flow marker or one or more interface pass by the one or more sensors in the nano flow meter, a liquid (e.g., a “second liquid”) can then be inserted into the opposite or second end of the capillary before the first and second fluid flow markers are dispelled from capillary. Introduction of the second liquid into second end of the capillary will then displace the first and second fluid flow markers back towards the first end, with the first and second fluid flow markers passing by the one or more sensors in the nano flow meter. FIG. 11 illustrates this principle using an admittance detector (“AD”) as an exemplary sensor. Thus, by alternating the introduction of liquids from the first end and the second end of the capillary, the same fluid flow marker can be repeatedly used. In some embodiments, nano flow meters described herein have the first end and the second end of the capillary each attached to a four-port value configured to reverse the flow direction in the capillary after each crossing of one or more fluid flow marker or one or more interface past the one or more sensors. The first and second liquids can come from the same flow stream, but due to the switching of one or more valves they enter opposite ends of the capillary.

Accordingly, methods described herein can optionally further comprise introducing a second liquid into the nano flow meter, the second liquid flowing into the fluid receiving space at the second end of the capillary at a second flow rate. The methods can further comprise displacing the fluid flow marker with the second liquid at the second flow rate away from the second end towards the first end of the capillary. In some embodiments, methods described herein can further comprise detecting a time of flight of the fluid flow marker past the one or more sensors to determine the second flow rate of the second liquid.

The flow meter is configured to measure flow rates of 100 nL/min or less. Examples of flow rates to be measured range from about 1 pL/min to about 100 nL/min, such as about 10 pL/min, to about 100 nL/min, about 100 pL/min, to about 100 nL/min, about 1 nL/min, to about 100 nL/min, about 10 nL/min, to about 100 nL/min, about 10 pL/min, to about 10 nL/min, about 10 pL/min, to about 1 nL/min, about 10 pL/min, to about 100 pL/min, and about 100 pL/min, to about 10 nL/min.

Embodiments described herein can be understood more readily by reference to the following detailed description, examples, and figures (referred to as “FIGS.”). Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

The terms “a” and “an” are defined as “one or more” unless this disclosure explicitly requires otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a composition or other object that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Moreover, any embodiment of any of the compositions, systems, and methods described herein can consist of, or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art. Furthermore, features from separate lists can be combined; and features from the examples can be generalized to the whole disclosure.

Some embodiments described herein are further illustrated in the following non-limiting examples. Unless otherwise noted herein, chemicals described in the following examples are available from standard chemical suppliers. Milli-Q water were used to prepare aqueous solutions. 50 mM ammonium acetate, hereinafter AA, was used as the conductive aqueous segment. Aqueous ammonium acetate at a lower concentration (0.5 mM) was used as the illustrative test fluid (TF), the flow of which was measured. All solutions were filtered through 0.45 μm Whatman poly(ether sulfone) membrane filters. The fluorocarbon chosen was Fluorinert® FC-40 oil, hereinafter denoted as FC. Trichloro(1H, 1H, 2H, 2H-perfluorooctyl)silane (TCPFOS) was used for fluorosilylation.

### EXAMPLES

### Example 1: Capillary Observation Tubes—Rendering a Silica Capillary Wall Fluorophilic

Silica capillaries of various inner diameters and 360 μm o.d., were used as the observation tubes. All of the data reported here, however, pertain to a 11 μm i.d., 35 cm long polyimide-coated fused silica capillary, unless stated otherwise.

To make a fluorophillic wall, the capillary was successively washed by 0.1 M ethanolic KOH, water, 0.1 M HCl and water, spending ca. 15 min at each step and finally dried by blowing filtered dry N₂ through it and TCPFOS was aspirated into it and left to react overnight. After the spent/excess reagent was forced out with N₂, the capillary was rinsed with FC. A comparison of the air-fluorocarbon interface between untreated and TCPFOS-treated fused silica capillaries indicates that the contact angle for FC markedly decreases upon TCPFOS treatment. FIGS. 8A and 8B show larger bore 180 μm capillaries and aqueous phase dyed with methylene blue for ready visualization. The center segment is fluorocarbon FC-40 in both figures. FIG. 8A shows a normal (untreated) fused silica capillary, and FIG. 8B shows a capillary that has been fluorosilylated. As shown, there is a dramatic change in the direction of curvature of both phases. Without fluorosilylation, in a hydrophilic capillary, over time the aqueous liquid slips past the FC segment.

### Example 2: Generation of Multi-Segment Fluid Flow Markers

The procedure for setting up multisegment flow markers includes a provision for simultaneously monitoring the flow by a reference method is as follows. In this example, mercury was used, since it offered a very visibly distinguishable marker under the microscope. The reference and measurement segments, separated by 1 cm, respectively comprised a ˜2 mm mercury segment in the middle of the test fluid and a FC/AA/FC (˜5/2/5 mm in length) train as the multisegment marker.

To help at least approximately achieve the desired marker lengths, a 10 cm length of the capillary was marked every mm with a fine-tip marker. All liquids were introduced into the capillary using dedicated 1 mL syringes using appropriate Luer adapters to threaded unions. The flow cell was first filled with the test fluid (TF). Then, 2 mm Hg, 1 cm TF, 5 mm FC, 2 mm AA, and 5 mm FC were injected in sequence. In all cases, the amount of the liquid initially introduced was longer than eventually intended. Mild back pressure was applied to expel the excess and the next liquid syringe was attached towards the end of this process. Finally, the mercury and segmental flow marker was pushed to the middle part of the flow cell by more test fluid. Note that aside from serving as the microscopic flow marker, the Hg segment served an important purpose, it allowed following the visualization of the introduction process of FC-AA-FC marker train, as the FC-AA interface was not easily discernible. Note that once assembled and calibrated, the sensor itself does not require mercury.

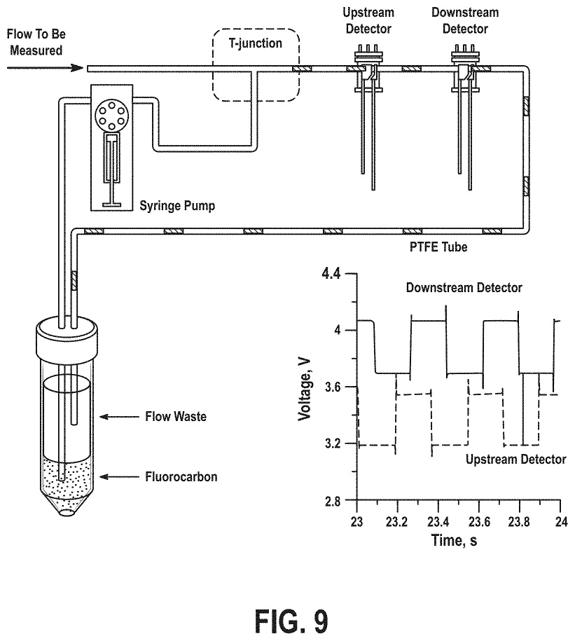

Both optical and admittance approaches were used. A simple red LED-photodiode based transmittance detector with a pinhole aperture successfully detected the interface in 300 μm i.d. PTFE tubes (FIG. 9). The test flow (5-500 μL/min) was generated by a syringe pump (Kloehn V6, www.norgren.com) and FC-40 markers were injected at regular intervals into the TF stream. The optical detector consisted simply of a flat-top 5 mm high brightness red LED on top which an adhesive Aluminum foil with a 300 μm drilled hole was placed with the guidance of a photodetector to maximize the light throughput. The actual emitter chip size is 250×250 μm; if excess plastic is removed from the LED top, and the surface re-polished, a 300 μm aperture allows the majority of the emitted light to be transmitted. A 30 LW PTFE tube (300 μm i.d., 600 μm o.d.,) was laid on top of the apertured LED and a lens-end photodiode equipped with an integrated high-gain transimpedance amplifier (TSL 257, www.ams.com) was laid thereon, on the other side of the tube. The assembly was held together with opaque adhesive tape. When the fluorocarbon segment passes through, more light reaches the detector as the refractive index of the FC better matches that of the PTFE wall and lower Fresnel loss increases light transmission compared to the aqueous TF in the light path. This method provided good flow rate measurements from 1 to 500 μL/min. The FC-AA interface was observable in a similar detector on a 28 μm i.d. tube if the AA phase was doped with a dye to decrease its light transmission further.

The circuitry for admittance detection is well known. Square wave excitation (15 V) at a fixed frequency of 6.6 kHz (optimized for the present application) from an LMC555 timer was used and a ultralow bias current (3 fA) transimpedance amplifier (LMP7721, located next to the pick-up electrode) was used before RMS→DC conversion (AD 536).

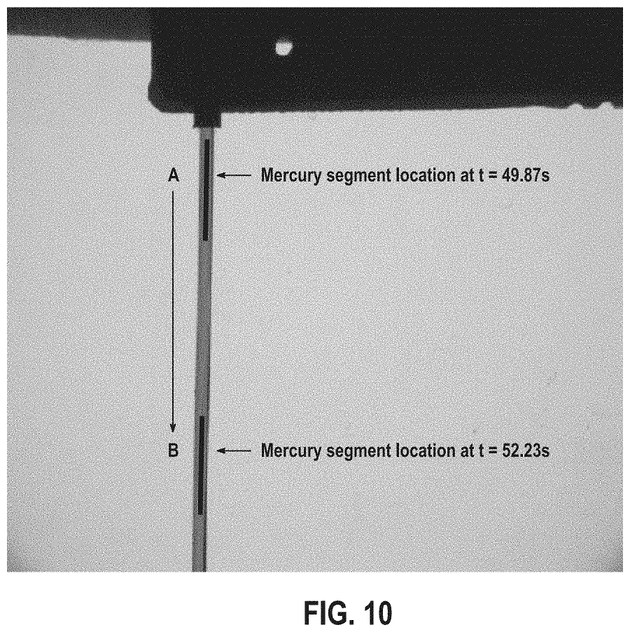

On either side of the admittance (or LED) detector based flow sensor, was the video microscopic flow measurement arrangement and the lowest flow rate (full scale 1500 nL/min) commercially available thermal mass flow sensor (MFS-1). The measurement calibration of the microscope was verified with a NIST-traceable graduated stage micrometer (10.0 μm reported by microscope as 9.99±0.05 μm, n=6). Flow rate was extracted from each Hg segment passage. Photoshop™ was used to separate each video (30 frames/s, 600×800 pixels, actual field of view 13×17.5 mm) into time-stamped frames. For each microscopic reference measurement, two frames at least several seconds apart (depending on the flow rate), were randomly selected from a single Hg segment passage. The TOF was calculated from the time interval. The two frames were merged into a single image (FIG. 10) and the distance coordinates computed by software (Grapher™), itself calibrated by the microscope-reported Hg segment length. The traversed distance was taken as the average of the distances respectively traveled by the leading edge and the trailing edge (the difference between these two numbers were statistically insignificant).

Microscopic examination of several cross-sectional segments cut adjacent to the nominally 10 μm i.d. observation capillary provided a mean±s.d. of 10.5±0.1 μm (6 cross sections, 18 measurements) for the capillary bore. The flow rates cited in this application were based on this observation.

Readout electronics and a LabVIEW™ interface was developed in-house for the Elveflow® sensor. The manufacturer's calibration equation was \Tₒᵤₜ=1.4717×F (μL/min)+2.5. In-house calibration in the 0-1 μL/min range (gravimetrically measured, 10 min collection period) was in very good agreement.

The test flow was pneumatically pumped by pressurized ultra-high purity grade N₂ via a high-resolution digital pressure controller (P/N MM1PBNKKZP100PSG, 6-100 psig, www.proportionair.com) from a custom-machined 25 mL capacity thick-wall Plexiglas reservoir (FIG. 2). The generated flow entered an electrically actuated 2-position 4-port valve (Cheminert® 03W-0030H) configured to reverse the flow direction in the capillary observation tube with each valve actuation. The reversal took place either after each complete crossing of the conductive marker or after an interface between to flow markers past the sensor FOP. FIG. 2 shows the exemplary test setup: NC, N₂ cylinder; DPR, digital pressure regulator; R, pressurized reservoir (left port, pressure inlet; right port, liquid outlet); V, four-port valve and its two positions; TMS Thermal mass flow sensor; FMT, flow marker train; AD, admittance detector; MFV, microscopic field of vision, W, waste (exit port). Arrows indicated flow directions in light/dark positions.

### Example 3: Detection Methods

### Optical Detector

To measure smaller flow rates the observation tube was 28 μm i.d. transparent cyclic olefin polymer (COP) capillary; 10 μL syringes were used for FC delivery and a custom zero dead volume capillary tee was used. Even with the smallest optical slit, the fluorocarbon water-interface was not discernible. The detector could see the interface if the transmission through the aqueous phase was reduced by incorporating high concentrations of a dye.

Using a mercury segment flanked by FCs, a reflective interface detection approach was explored. Such a detector is very simple and inexpensive to construct as it requires no special optical aperture or slit arrangement. The initial trial clearly showed that a Hg—FC interface is easily detected even in the 11 μm i.d. capillary. Further contrast between light reflected by a metallic surface from light scattered by glass or Fresnel reflection is used in some embodiments through the use of a polarizing filter.

### Admittance Detector

Simple on-tube admittance detectors can pick up small changes in interior fluid composition, even in capillaries as small as 2 μm in i.d. It is worthwhile to note that capacitance to voltage converters (e.g., AD7746), available inexpensively as complete evaluation boards, can also sense small changes in fluid composition within a tube.

In an admittance detector the field is capacitively coupled to the solution. It has been observed that the applied field extends beyond the electrode gap.

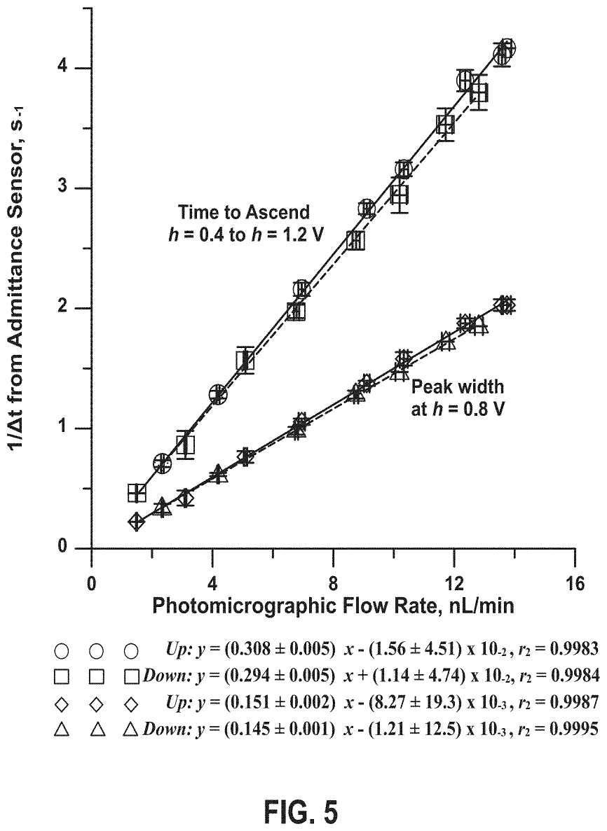

The response behavior of the admittance sensor at low flow rates (approaching 1 nL/min) is shown in FIG. 4. FIG. 4 shows the response of the admittance sensor to flow of the test fluid (0.5 mM ammonium acetate) from 1.7 to 13.5 nL/min. The electrodes are both 6 mm. In some embodiments, the gap between electrodes can range from about 0.1 mm to about 10 mm, such as about 0.5. The 10.5 μm i.d. capillary is fluorosilylated. The multisegment marker consists of a 50 mM ammonium acetate (˜2 mm) “conductive” segment flanked by a ˜5 and ˜10 mm FC segment. The ordinate scale is shown for the lowest trace. The same scaling applies to all the traces but the baselines have been offset for clarity. The inset shows a replicate of the detector trace for the lowest flow rate. FIG. 5 shows the width of the peak at a signal height of 0.8 V (close to half-height, base line and apex respectively being 0.2 and 1.3 V); and also shows data for the time for the signal to rise from 0.4 to 1.2 V as the respective measurements. Both approaches show comparable parameters of linearity and measurement uncertainty, but the latter takes less time and flow can be reversed without the entire marker having to pass through. Measurement can then be made on the descending signal. Note that the lowest output values (baseline output) with the FC segments completely filling the gap is at ˜0.2 V, close to but not at zero output voltage. The stability of the baseline is thus a true indication of the detector stability. However, such sensors respond nonlinearly with the solution conductance. At high gain (presently used transimpedance gain is 0.5 V/nA) and at higher conductivities, the detector approaches a plateau signal in an asymptotic fashion—the difference between the steady state output from 0.5 mM or 50 mM NH₄OAc (or for that matter a metallic conductor like Hg) segment filling the detector is not proportional to their actual conductivities.

There are myriad possible approaches to relate the observed or derived parameters from the detector output to the microscopically observed flow rate. In some embodiments, the half width of the response peak elicited by the conductive segment is used. In reality, the measurement need not be the half-width, it can be the interval between any two chosen reference voltages on the ascending and descending parts of the response. There is no special significance to measuring the width at any specific relative peak height, it is important to note that if the conductive segment is long enough, the response can be flat-topped. FIG. 5 shows results interpreted with peak width at a signal height of 0.8 V as the measurand (lower pair of lines, with hollow or filled diamonds) or the time for the signal to rise from 0.4 V to 1.2 V (higher pair of lines with hollow or filled circles) as the signal ascends. Thus, the first set of data involves both interface edges flanking a given marker segment passing through the sensor FOP, while the second set involves the movement of a single interface edge in the FOP. In each of the above sets, hollow and the filled symbols respectively represent up and down flows in a vertically oriented sensor. Both x- and y-error bars indicate ±1 SD (n≥3). Lowest flow rate: 1.48 nL/min.

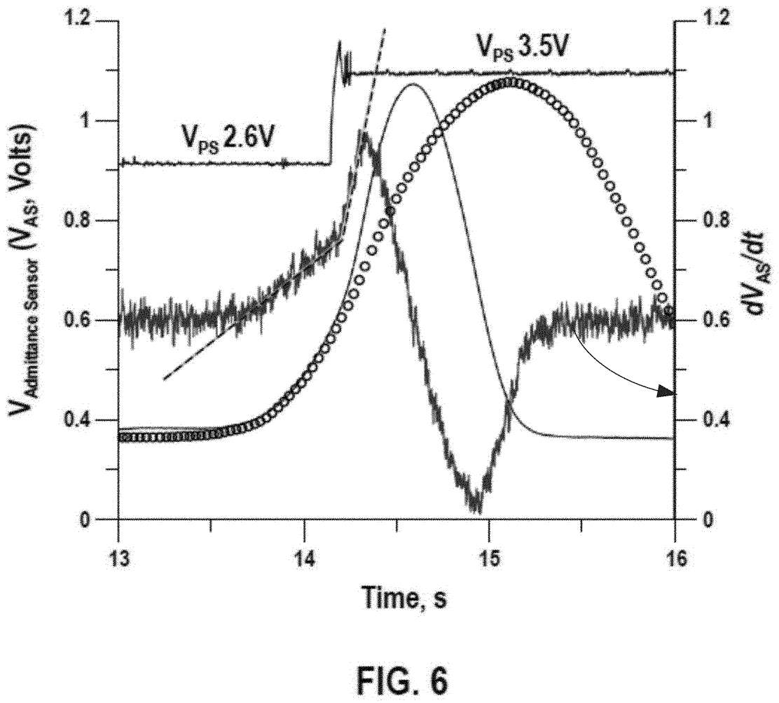

In some embodiments, a single interface edge is sensed multiple times as the direction of the flow of the fluid markers is reversed back and forth. FIG. 6 shows sensor response speed based on the movement of a single interface edge with data being acquired at a rate of 1 kHz. During the passage of the fluid flow marker interface, the pneumatic pressure on the delivery reservoir was abruptly changed (t=14.16 s). Based on the pressure sensor output (V_{PS}), the pressure changed in ˜40 ms and stabilized in ˜420 ms. The solid black line depicts the admittance signal. The hollow symbols depict an experiment where V_{PS} remained constant at 2.6 V. The noisy signal starting at 0.6 V is the derivative of the admittance signal (20 point moving average applied). Note that the slope observably changes within 100 ms of V_{PS} change. The data thus shows that any flow change during such an event can be observed in a sub-second time scale. The change in the slope is more readily apparent in a second derivative plot.

### Lag Time in Response

Repeat experiments that involve stepping up or down in flow indicate no difference in the lag period if the flow is increased or decreased. The difference of the lag time on flow direction, 76±46 vs. 49±21 ms was not statistically significant. Small differences in electrode lengths on each side may play a role in this observation.

### Linearity of Response

For the single interface movement sensing strategy, the relationship of the reciprocal of the time interval (Δt) between two randomly chosen signal values and the flow rate were examined to determine what choice of these signal values provide best linearity. While a linear relationship such as that in FIG. 5 holds when these voltage points chosen are relatively far apart, a more generally applicable linear relationship is observed regardless of the choice of these signal voltage points if a ln (Δt) is plotted against ln (flow rate).

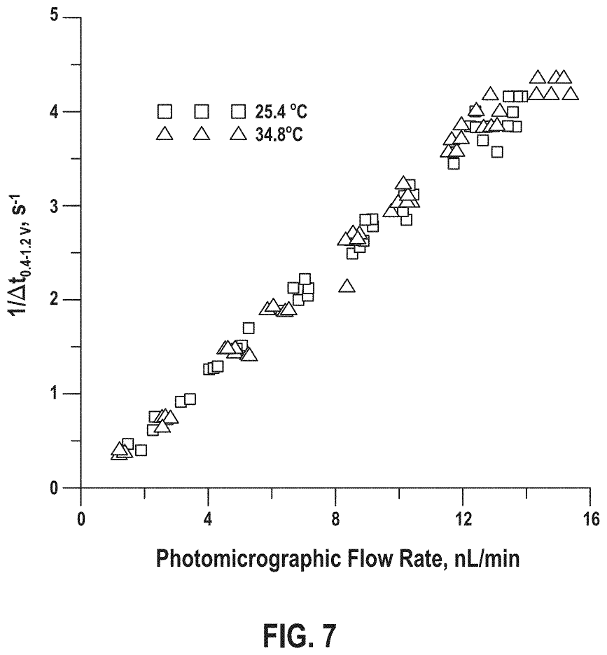

The effects of temperature on sensor output was explored. Compared to thermal expansion coefficient of liquids (for example, water around 25° C. is ˜2.5×10⁻⁴/° C.), that for fused silica is far smaller (˜5×10⁻⁷/° C.). Calibration shift because of a change in i.d. of a silica tube due to a 10° C. change will be negligible. In fact, the change in the volume of water for that degree of temperature change will be 0.25%, barely detectable in many embodiments described herein. As FIG. 7 indicates, there does not appear to be any such effect. As shown in FIG. 7, a 10° C. change in temperature has no discernible systematic effect on the system behavior as judged by the reciprocal of the time interval from for the admittance signal to rise from 0.4 to 1.2 V. The flow rate range is 1.25-15 nL/min.

In summary, a relatively simple, inexpensive and robust sensor for measuring flow rates in the low nL/min range is disclosed. Additionally, the sensor in some instances can easily be extendable to even lower flow rates. As demonstrated, the passage of an interface between two liquids, even a partial passage, through the FOP of the sensor can measure low flow rates.

What is claimed is:

1. A flow meter comprising:
a capillary having a fluid receiving space, with a first end and a second end;
a first fluid flow marker;
a second fluid flow marker that is immiscible with the first fluid flow marker, the first and second fluid flow markers being positioned in the fluid receiving space, wherein the first fluid flow marker is adjacent to the second fluid flow marker; and
one or more sensors positioned along the capillary.

2. The flow meter of claim 1, further comprising a plurality of first fluid flow markers and a plurality of second fluid flow markers, wherein the first and second fluid flow markers are positioned in an alternating sequence of fluid flow markers.

3. The flow meter of claim 1, wherein one or more sensor is selected from an optical sensor, an admittance sensor, and a capacitance sensor.

4. The flow meter of claim 1, wherein the second fluid flow marker is a fluorocarbon.

5. The flow meter of claim 4, wherein the first fluid flow marker is an aqueous salt solution, an ionic liquid, or a liquid metal.

6. The flow meter of claim 5, wherein the first flow marker is optically reflective.

7. The flow meter of claim 1, wherein the capillary comprises silica and the interior surface is at least partially fluorophilic.

8. The flow meter of claim 1, wherein the capillary comprises polytetrafluoroethylene.

9. The flow meter of claim 1, further comprising a valve comprising a first port, a second port, a third port, and a fourth port,
wherein the flow meter is configured so that the first end of the capillary is fluidly connected to the first port of the valve and the second end of the capillary is fluidly connected to the second port of the valve, the third port is fluidly connected to the flow to be measured, the fourth port is the exit port,
wherein the valve comprises two positions, a first position and a second position;
in the first position, the valve is configured to fluidly connect the flow to be measured with the first end of the capillary and the second end of the capillary to the exit port,
in the second position, the valve is configured to fluidly connect the flow to be measured with the second end of the capillary and the first end of the capillary to the exit port.

10. The flow meter of claim 1, comprising one or more valves configured so that the flow direction of the first and second flow markers in the capillary may be reversed to allow them to flow in both directions in front of the one or more sensors.

11. The flow meter of claim 1, wherein the flow meter is configured to measure flow rates of 100 nL/min or less.

12. A method for measuring flow rates comprising the steps of:
introducing a first liquid into a flow meter, the first liquid flowing into the fluid receiving space at the first end of the capillary thereby displacing the first fluid flow marker and the second fluid flow marker towards the second end of the capillary;
measuring one or more interfaces between the first fluid flow marker and the second fluid flow marker with one or more sensors to determine the flow rate of the first liquid;
wherein the flow meter comprises
a capillary having a fluid receiving space, with a first end and a second end;
a first fluid flow marker;
a second fluid flow marker that is immiscible with the first fluid flow marker, the first and second fluid flow markers being positioned in the fluid receiving space, wherein the first fluid flow marker is adjacent to the second fluid flow marker; and
one or more sensors positioned along the capillary.

13. The method of claim 12, further comprising:
introducing a second liquid into nano flow meter, the second liquid flowing into the fluid receiving space at the second end of the capillary thereby displacing the first fluid flow marker and the second fluid flow marker towards the first end of the capillary.

14. The method of claim 12, wherein the flow meter further comprises one or more valves configured so that the flow direction of the first and second flow markers in the capillary may be reversed to allow them to flow in both directions in front of the one or more sensors.

15. The method of claim 12, wherein one or more sensor is an admittance sensor.

16. The method of claim 15, wherein one or more sensor measures the passage of the interface between a first and second fluid flow marker.

17. The method of claim 12, wherein the flow meter is configured to measure flow of rates of 5 nL/min or less.

18. The method of claim 12, comprising:
measuring a change of dielectric constant or resistivity due to the passage of the interface between the first fluid flow marker and the second fluid flow marker with one or more sensors, and calculating the flow rate of the first liquid from that rate of change.

19. The method of claim 12, comprising:
measuring the time it takes for a fluid flow marker to pass, and calculating the flow rate of the first liquid from the length of the fluid flow marker measured and the amount of time it took to pass.
